(19) United States
(12) Patent Application Publication
(10) Pub. No.: US 2020/0037128 A1
(43) Pub. Date: Jan. 30, 2020

(54) SYSTEM AND METHOD FOR VEHICLE-TO-EVERYTHING (V2X) COMMUNICATION

(71) Applicant: QUALCOMM Incorporated, San Diego, CA (US)

(72) Inventors: Feng LU, Santa Clara, CA (US); Cheol Hee PARK, San Diego, CA (US); Cheng TAN, Denver, CO (US); Edmund Victor SIMMONS, Boulder, CO (US); Sean Vincent MASCHUE, Encinitas, CA (US); Sivaramakrishna VEEREPALLI, San Diego, CA (US); Arvind Vardarajan SANTHANAM, San Diego, CA (US); Subramanya RAO, Sunnyvale, CA (US)

(21) Appl. No.: 16/515,899

(22) Filed: Jul. 18, 2019

Related U.S. Application Data
(60) Provisional application No. 62/711,971, filed on Jul. 30, 2018.

(51) Int. Cl. H04W 4/40; H04L 27/26; H04B 7/06; H04W 72/12; H04L 1/18

(52) U.S. Cl. CPC H04W 4/40; H04L 27/2627; H04L 1/1812; H04W 72/12; H04B 7/0602

(57) ABSTRACT

This disclosure discloses various vehicle-to-everything (V2X) wireless communication processes that use switching diversity to improve coverage over that of a single transmit antenna. Switching diversity may be implemented by alternating the transmit antennas according to a certain switching pattern. A V2X device determines a pattern for alternating a plurality of antennas for transmitting data packets. The V2X device selects, based on the pattern, a first antenna of the plurality of antennas, and transmit a first packet of the data packets using the first antenna. The V2X device further select, based on the pattern, a second antenna of the plurality of antennas, and transmit a second packet of the data packets using the second antenna.

### PRIORITY CLAIM

This application claims priority to and the benefit of provisional patent application No. 62/711,971 filed in the United States Patent Office on Jul. 30, 2018, the entire content of which is incorporated herein by reference as if fully set forth below in its entirety and for all applicable purposes.

### TECHNICAL FIELD

The technology discussed below relates generally to wireless communication systems, and more particularly, to vehicle-to-everything communications.

### INTRODUCTION

Wireless communication devices, sometimes referred to as user equipment (UE), may communicate with a base station or may communicate directly with another UE. When a UE communicates directly with another UE, the communication is referred to as device-to-device (D2D) communication. In particular use cases, a UE may be a wireless communication device, such as a portable cellular device, or may be a vehicle, such as an automobile, a drone, or may be any other connected device. When the UE is a vehicle, such as an automobile, a D2D communication with another device may be referred to as vehicle-to-everything (V2X) communication, which may include vehicle-to-vehicle (V2V), vehicle-to-infrastructure (V2I), vehicle-to-network (V2N), and vehicle-to-pedestrian (V2P), etc. V2X communication and particularly, V2V communication may impact various applications, for example, collision avoidance and autonomous driving.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

One aspect of the present disclosure provides a method of vehicle-to-everything (V2X) wireless communication operable at a user equipment (UE). A V2X device determines a pattern for alternating a plurality of antennas operatively coupled to the UE for transmitting data packets. The V2X device selects, based on the pattern, a first antenna of the plurality of antennas. The V2X device transmits a first packet of the data packets using the first antenna. The V2X device selects, based on the pattern, a second antenna of the plurality of antennas. The V2X device transmits a second packet of the data packets using the second antenna.

Another aspect of the present disclosure provides a user equipment (UE) for use in vehicle-to-everything (V2X) wireless communication. The UE includes a communication interface configured for wireless communication using a plurality of antennas, a memory, and a processor operatively coupled with the communication interface and the memory. The processor and the memory are configured to determine a pattern for alternating the plurality of antennas for transmitting data packets. The processor and the memory are further configured to select, based on the pattern, a first antenna of the plurality of antennas. The processor and the memory are further configured to transmit a first packet of the data packets using the first antenna. The processor and the memory are further configured to select, based on the pattern, a second antenna of the plurality of antennas. The processor and the memory are further configured to transmit a second packet of the data packets using the second antenna.

Another aspect of the present disclosure provides a user equipment (UE) configured for vehicle-to-everything (V2X) wireless communication. The UE includes means for determining a pattern for alternating a plurality of antennas for transmitting data packets. The UE further includes means for selecting, based on the pattern, a first antenna of the plurality of antennas. The UE further includes means for transmitting a first packet of the data packets using the first antenna. The UE further includes means for selecting, based on the pattern, a second antenna of the plurality of antennas. The UE further includes means for transmitting a second packet of the data packets using the second antenna.

Another aspect of the present disclosure provides an article of manufacture for use by a user equipment (UE) for vehicle-to-everything (V2X) wireless communication. The article includes a non-transitory computer-readable storage medium having stored therein instructions executable by one or more processors of the UE. The one or more processors execute the instructions to determine a pattern for alternating a plurality of antennas for transmitting data packets. The one or more processors further execute the instructions to select, based on the pattern, a first antenna of the plurality of antennas. The one or more processors further execute the instructions to initiate transmission of a first packet of the data packets using the first antenna. The one or more processors further execute the instructions to select, based on the pattern, a second antenna of the plurality of antennas. The one or more processors further execute the instructions to initiate transmission of a second packet of the data packets using the second antenna.

These and other aspects of the invention will become more fully understood upon a review of the detailed description, which follows. Other aspects, features, and embodiments will become apparent to those of ordinary skill in the art, upon reviewing the following description of specific, exemplary embodiments in conjunction with the accompanying figures. While features may be discussed relative to certain embodiments and figures below, all embodiments can include one or more of the advantageous features discussed herein. In other words, while one or more embodiments may be discussed as having certain advantageous features, one or more of such features may also be used in accordance with the various embodiments discussed herein. In a similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a schematic illustration of a wireless communication system according to some aspects of the present disclosure.

FIG. 2 is a conceptual illustration of an example of a radio access network according to some aspects of the present disclosure.

FIG. 3 is a diagram conceptually illustrating exemplary vehicle-to-everything (V2X) communication using a single antenna according to some aspects of the disclosure.

FIG. 4 is a diagram conceptually illustrating exemplary V2X communication using switching diversity according to some aspects of the disclosure.

FIG. 5 is a diagram illustrating an exemplary communication process for transmitting V2X data packets with retransmission enabled using switching diversity according to some aspects of the disclosure.

FIG. 6 is a diagram illustrating an exemplary communication process for transmitting V2X packets with retransmission disabled using switching diversity according to some aspects of the disclosure.

FIG. 7 is a diagram illustrating an antenna switching timeline when using switching diversity according to some aspects of the disclosure.

FIG. 8 is a block diagram conceptually illustrating an example of a hardware implementation for a V2X device according to some aspects of the disclosure.

FIG. 9 is a flow chart illustrating a process for V2X communication using switching diversity according to some aspects of the disclosure.

FIG. 10 is a flow chart illustrating a V2X transmit diversity procedure according to some aspects of the disclosure.

FIG. 11 is a flow chart illustrating a process for alternating antennas in V2X communication according to some aspects of the disclosure.

FIG. 12 is a flow chart illustrating another process for alternating antennas in

V2X communication according to some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily include a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes and constitution.

Aspects of the present disclosure are directed to device-to-device (D2D) and, more particularly, vehicle-to-everything (V2X) wireless communication using switching diversity to improve coverage over that of a single transmit antenna. Switching diversity may be implemented by alternating the transmit antennas according to a certain switching pattern. D2D communication may also be referred to as point-to-point (P2P) communication in some applications. In some examples, D2D enables discovery of, and communication with nearby devices using a direct link between the devices (i.e., without passing through a base station, relay, or another node). D2D can enable mesh networks, V2X, and device-to-network relay functionality. Some examples of D2D technology include Bluetooth pairing, Wi-Fi Direct, Miracast, and LTE-D. In various aspects of the disclosure, a device (e.g., a vehicle or a user equipment) transmits data packets while alternating the transmit antennas to overcome antenna placement constraints and/or unfavorable radiation patterns. In this disclosure, the described V2X wireless communication processes may be used in various device-to-device communication systems, and is not limited to V2X or the like.

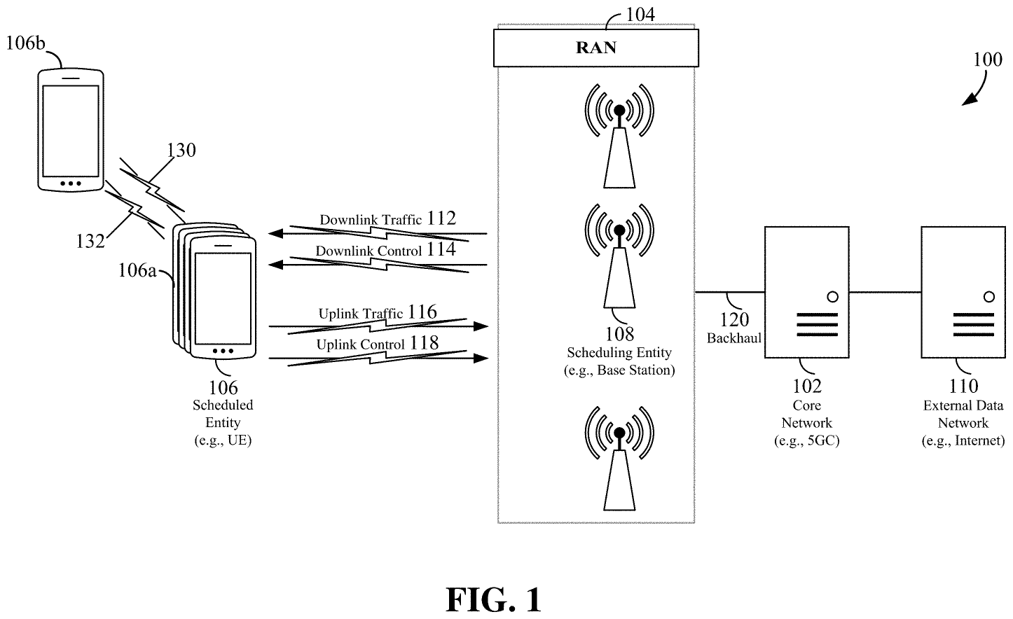

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. In some examples, the UE 106 may be a vehicle capable of wireless communication. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3^{rd} Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), or some other suitable terminology.

The radio access network 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In some examples, the mobile apparatus may a vehicle with wireless communication capability. A UE may be an apparatus (e.g., a mobile apparatus) that provides a user with access to network services.

Within the present document, a “mobile” apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smartwatch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment; military defense equipment, vehicles, aircraft, ships, and weaponry, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs, which may be scheduled entities 106, may utilize resources allocated by the scheduling entity 108. In some examples, the scheduling entity may also be responsible for scheduling, assigning, reconfiguring, and releasing resources for D2D (e.g., V2X) communications. For example, when a scheduled entity 106 enters an area covered by a scheduling entity 108, the scheduling entity 108 may allocate V2X resources to the scheduled entity.

Base stations 108 are not the only entities that may function as scheduling entities. That is, in some examples, a UE may function as a scheduling entity, scheduling resources for one or more scheduled entities (e.g., one or more other UEs). In one example, a UE may be responsible for scheduling, assigning, reconfiguring, and releasing resources for D2D (e.g., V2X) communications.

As illustrated in FIG. 1, a scheduling entity 108 may broadcast downlink traffic 112 to one or more scheduled entities 106. Broadly, the scheduling entity 108 is a node or device responsible for scheduling traffic in a wireless communication network, including the downlink traffic 112 and, in some examples, uplink traffic 116 from one or more scheduled entities 106 to the scheduling entity 108. On the other hand, the scheduled entity 106 is a node or device that receives downlink control information 114, including but not limited to scheduling information (e.g., a grant), synchronization or timing information, or other control information from another entity in the wireless communication network such as the scheduling entity 108.

In general, base stations 108 may include a backhaul interface for communication with a backhaul portion 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

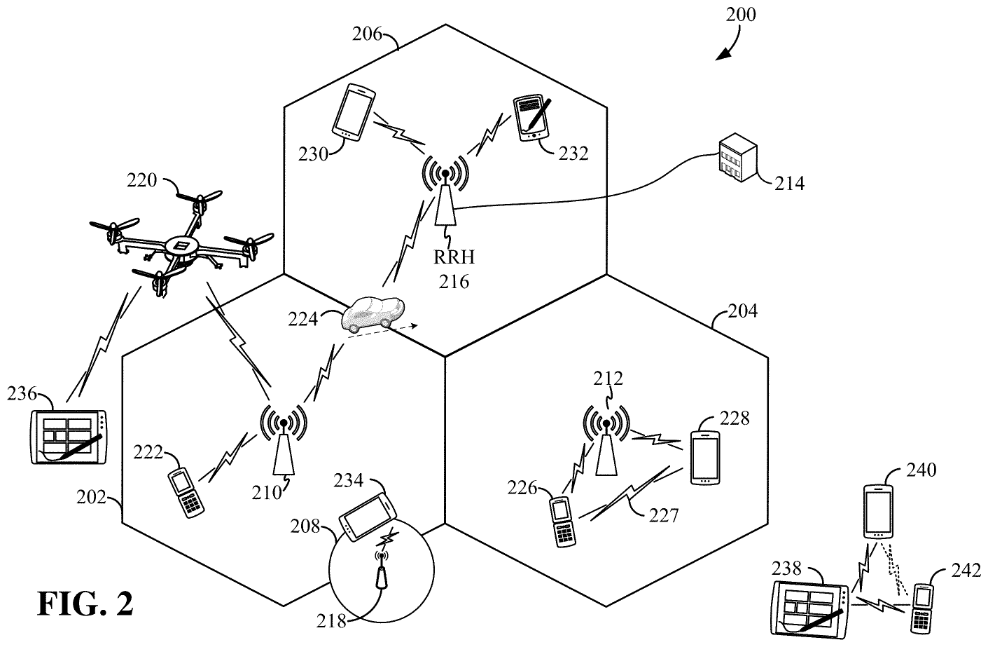

Referring now to FIG. 2, by way of example and without limitation, a schematic illustration of a RAN 200 is provided. In some examples, the RAN 200 may be the same as the RAN 104 described above and illustrated in FIG. 1. The geographic area covered by the RAN 200 may be divided into cellular regions (cells) that can be uniquely identified by a user equipment (UE) based on an identification broadcasted from one access point or base station. FIG. 2 illustrates macrocells 202, 204, and 206, and a small cell 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

In some aspects of the disclosure, scheduled entities (e.g., a first scheduled entity 106a and a second scheduled entity 106b) may utilize sidelink signals for D2D communication (e.g., V2X communication). Sidelink signals may include sidelink traffic 130 and sidelink control 132. In some examples, the sidelink control 132 may include synchronization information to synchronize communication on the sidelink channel. In addition, the sidelink control 132 may include scheduling information indicating one or more resource blocks reserved by the transmitting sidelink device to transmit the sidelink traffic 130 to the receiving sidelink device. In some examples, the scheduling information may further include information related to the traffic 130, such as a modulation and coding scheme utilized for the traffic 130. In some examples, the sidelink control 132 may be transmitted within a physical sidelink control channel (PSCCH), while the sidelink data 130 may be transmitted within a physical sidelink shared channel (PSSCH).

In FIG. 2, two base stations 210 and 212 are shown in cells 202 and 204; and a third base station 214 is shown controlling a remote radio head (RRH) 216 in cell 206. That is, a base station can have an integrated antenna or can be connected to an antenna or RRH by feeder cables. In the illustrated example, the cells 202, 204, and 126 may be referred to as macrocells, as the base stations 210, 212, and 214 support cells having a large size. Further, a base station 218 is shown in the small cell 208 (e.g., a microcell, picocell, femtocell, home base station, home Node B, home eNode B, etc.) which may overlap with one or more macrocells. In this example, the cell 208 may be referred to as a small cell, as the base station 218 supports a cell having a relatively small size. Cell sizing can be done according to system design as well as component constraints.

It is to be understood that the radio access network 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity 108 described above and illustrated in FIG. 1.

FIG. 2 further includes a quadcopter or drone 220, which may be configured to function as a base station. That is, in some examples, a cell may not necessarily be stationary, and the geographic area of the cell may move according to the location of a mobile base station such as the quadcopter 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as the UE/scheduled entity 106 described above and illustrated in FIG. 1.

In some examples, a mobile network node (e.g., quadcopter 220) may be configured to function as a UE. For example, the quadcopter 220 may operate within cell 202 by communicating with base station 210.

In a further aspect of the RAN 200, sidelink signals may be used between UEs without necessarily relying on scheduling or control information from a base station. For example, two or more UEs (e.g., UEs 226 and 228) may communicate with each other using peer-to-peer (P2P) or sidelink signals 227 without relaying that communication through a base station (e.g., base station 212). In a further example, UE 238 is illustrated communicating with UEs 240 and 242. Here, the UE 238 may function as a scheduling entity or a primary sidelink device, and UEs 240 and 242 may function as a scheduled entity or a non-primary (e.g., secondary) sidelink device. In still another example, a UE may function as a scheduling entity in a device-to-device (D2D), peer-to-peer (P2P), or vehicle-to-vehicle (V2V) network, a vehicle-to-everything (V2X) network, and/or in a mesh network. In a mesh network example, UEs 240 and 242 may optionally communicate directly with one another in addition to communicating with the scheduling entity 238. Thus, in a wireless communication system with scheduled access to time-frequency resources and having a cellular configuration, a P2P configuration, or a mesh configuration, a scheduling entity and one or more scheduled entities may communicate utilizing the scheduled resources.

The air interface in the radio access network 200 may utilize one or more duplexing algorithms. Duplex refers to a point-to-point communication link where both endpoints can communicate with one another in both directions. Full duplex means both endpoints can simultaneously communicate with one another. Half duplex means only one endpoint can send information to the other at a time. In a wireless link, a full duplex channel generally relies on physical isolation of a transmitter and receiver, and suitable interference cancellation technologies. Full duplex emulation is frequently implemented for wireless links by utilizing frequency division duplex (FDD) or time division duplex (TDD). In FDD, transmissions in different directions operate at different carrier frequencies. In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot.

The air interface in the radio access network 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from the base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier I-DMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

In a DL transmission, the transmitting device (e.g., the scheduling entity 108) may transmit DL control information 114 including one or more DL control channels that generally carry information originating from higher layers, such as a physical broadcast channel (PBCH), a physical downlink control channel (PDCCH), etc., to one or more scheduled entities 106. The PDCCH may carry downlink control information (DCI) for one or more UEs in a cell. This can include, but is not limited to, power control commands, scheduling information, a grant, and/or an assignment of resources for DL and UL transmissions.

In an UL transmission, a transmitting device (e.g., a scheduled entity 106) may transmit UL control information 118 (UCI) via one or more UL control channels, such as a physical uplink control channel (PUCCH), a physical random access channel (PRACH), etc., to the scheduling entity 108. In some examples, the control information 118 may include a scheduling request (SR), i.e., a request for the scheduling entity 108 to schedule uplink transmissions. Here, in response to the SR transmitted on the control channel 118, the scheduling entity 108 may transmit downlink control information 114 that may schedule resources for uplink packet transmissions.

UL control information may also include hybrid automatic repeat request (HARQ) feedback such as an acknowledgment (ACK) or negative acknowledgment (NACK), channel state information (CSI), or any other suitable UL control information. HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission confirmed, an ACK may be transmitted, whereas if not confirmed, a NACK may be transmitted. In response to a NACK, the transmitting device may send a HARQ retransmission, which may implement chase combining, incremental redundancy, etc.

In some aspects of the present disclosure, HARQ or similar retransmission techniques described above may be used in sidelink communication, for example, V2X, P2P, and D2D communication.

In addition to control information, the transmitting device may transmit user data or traffic data on one or more traffic channels, such as, for a DL transmission, a physical downlink shared channel (PDSCH); or for an UL transmission, a physical uplink shared channel (PUSCH).

### V2X Communication—Single Antenna

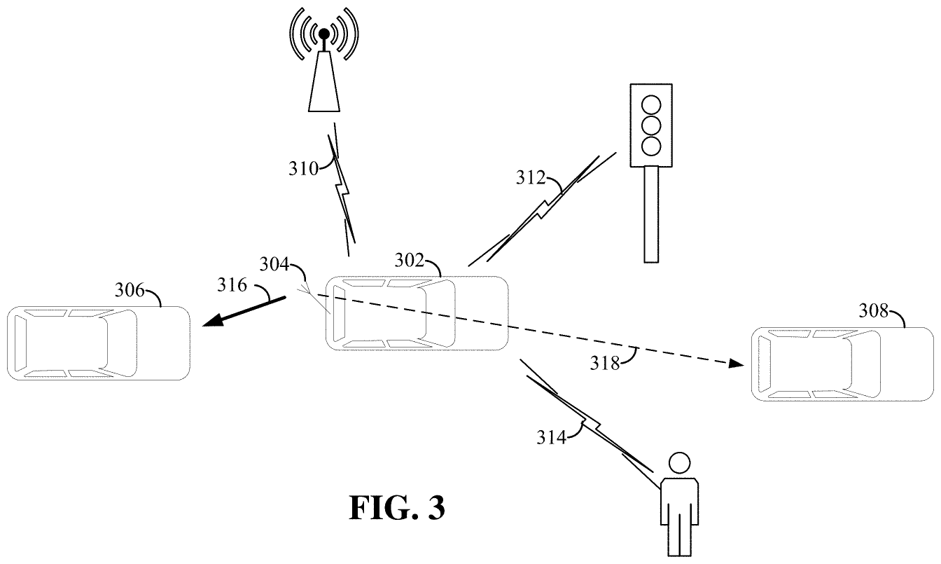

FIG. 3 is a diagram conceptually illustrating exemplary vehicle-to-everything (V2X) communication using a single antenna according to some aspects of the disclosure. A first vehicle 302 is equipped with a single transmit antenna 304 for V2X communication with other nearby devices. For example, the first vehicle 302 may communicate with a second vehicle 306 at the back and a third vehicle 308 in front using V2X communication. The first vehicle 302 may also engage in V2N communication with base stations 310, V2I communication with traffic control 312, and/or V2P communication with pedestrians 314. However, the placement and/or form factor of the single antenna 304 may not provide complete (e.g., 360-degree) all-around coverage, for example, for safety applications supported by V2X communication. In this example, the single antenna 304 may provide good coverage in a backward direction 316 toward the second vehicle 306, but may have a coverage null in a forward direction 318 toward the third vehicle 308. In this case, the vehicle 302 within a single antenna may not be able to establish and/or maintain a working or reliable V2X communication with the third vehicle 308 in front.

### V2X Communication—Switching Diversity

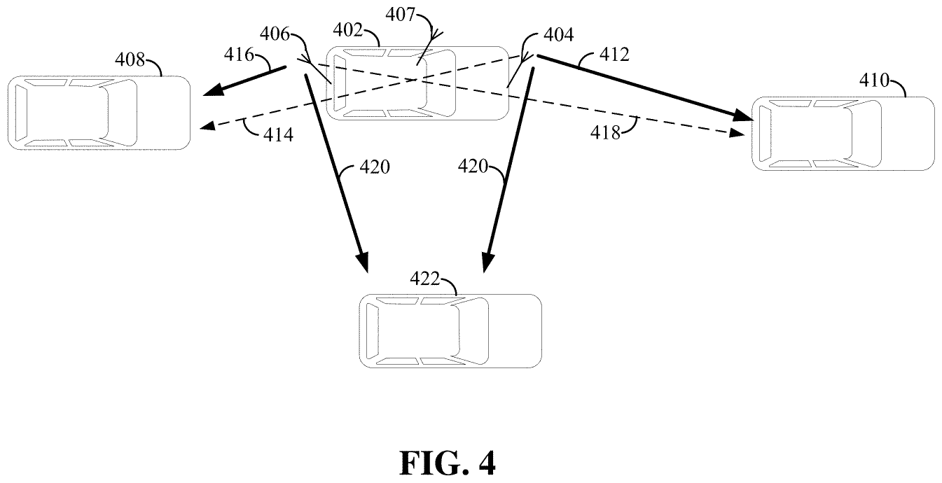

FIG. 4 is a diagram conceptually illustrating exemplary V2X communication using switching diversity according to some aspects of the disclosure. In this example, a V2X device 402 (e.g., first vehicle) may transmit V2X data packets using two or more alternating transmit antennas (e.g., antennas 404, 406, 407) to communicate with nearby V2X devices (e.g., second vehicle 408 and third vehicle 410). In some examples, the V2X device may be a UE or a vehicle capable of V2X communication. In some examples, the V2X device may be a UE that is operatively coupled to one or more external antennas (e.g., antennas 404, 406, 407) of a vehicle. In some examples, the V2X device may be a UE that uses one or more internal antennas and one or more external antennas (e.g., antennas 404, 406, 407 on a vehicle) that are operatively coupled to the UE, for V2X communication. For example, a UE may connect to an external antenna of a vehicle via a wired or wireless connection provided by the vehicle. In this case, switching diversity is achieved by alternating the antennas used for transmitting the data packets. Switching or alternating two or more antennas can provide better coverage compared to that of the single fixed transmit antenna case described in relation to FIG. 3. While only V2V communication is illustrated in FIG. 4, other types of V2X communication (e.g., V2I, V2N, and V2P) are also contemplated. In this example, the front antenna 404 has good coverage in a forward direction 412 toward the front vehicle 410, but may have a coverage null in a backward direction 414. Antenna coverage is considered good when there is none or few obstacles that can block or impede signal propagation in the desired direction. The rear antenna 406 has good coverage in a backward direction 416 toward the vehicle 408 at the back, but may have a coverage null in a forward direction 418. A coverage null may refer to an area where the V2X signal is weaker than a predetermined threshold (e.g., signal strength, signal-to-noise ratio). In this case, alternating the antennas during V2X communication may reduce or even remove any null area around the vehicle. Furthermore, using multiple switching antennas may provide redundant coverage 420, for example, to a third vehicle 422 on the side of the first vehicle 402.

In various aspects of the disclosure, a device (e.g., vehicle, UE) may use V2X communication to transmit V2X data packets on two or more alternating or switching transmit (Tx) antennas to improve communication coverage and/or reliability. In one aspect of the disclosure, when packet retransmission (e.g., HARQ) is enabled, the device alternates the Tx antennas and encodes the packets using self-decodable MCS. In one aspect of the disclosure, when retransmission is enabled, the device transmits a packet and a retransmission of the packet on alternating antennas. In one aspect of the disclosure, when retransmission is not enabled, the device transmits successive packets (e.g., a sequence of data packets) on alternating Tx antennas.

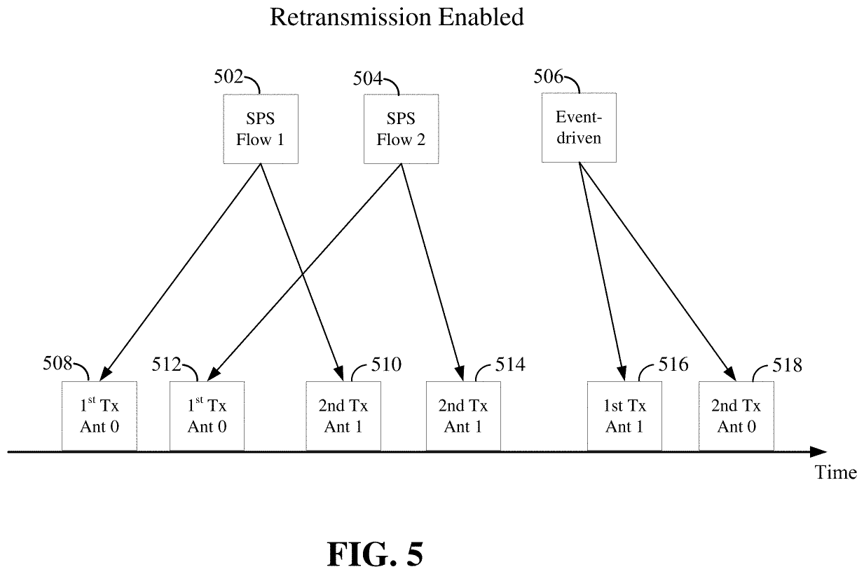

FIG. 5 is a diagram illustrating an exemplary communication process for transmitting V2X data packets with retransmission enabled using switching diversity according to some aspects of the disclosure. This process may be performed using any device (e.g., UE or vehicle) illustrated in any of FIGS. 1, 2, 3, and/or 4 or any suitable apparatus. In one example, a device (e.g., first vehicle 402 of FIG. 4) may transmit two semi-persistent scheduled (SPS) data flows (e.g., SPS flows 502, 504) and an event-driven data flow (e.g., event-driven flow 506). In some examples, the SPS flows may be scheduled by a scheduling entity 108 (e.g., a base station, eNB, gNB) via radio resource control (RRC) signaling or other semi-persistent scheduling methods. When using semi-persistent scheduling, the scheduling entity may allocate resources (e.g., time-frequency resources, coding sequence, etc.) that can be maintained for a predetermined period so that the resources need not be repeatedly allocated, for example, per TTI, slot, or subframe. An SPS flow may remain effective until it is rescheduled or canceled. The device may transmit SPS flow packets periodically or according to a predetermined schedule. Some examples of SPS flow packets are short periodic V2X safety messages such as basic safety message (BSM), signal phase and time (SPAT), and cooperative awareness message (CAM). An event-driven flow may occur in response to certain predetermined events or conditions. For example, the device may detect a nearby vehicle and attempt to communicate with the nearby devices (e.g., vehicles) using the event-driven flow 506. In some examples, the event-driven flow 506 may include packets that are related to proximity sensing and/or collision avoidance in V2X communication. In some examples, packets of an event-driven flow may be non-periodic or transmitted as messages with long periodicities, such as map data message (MAP) and traffic information message (TIM).

Referring to FIG. 5, when packet retransmission is enabled, for each SPS flow and event-driven flow, the device transmits a packet and a retransmitted packet on alternating Tx antennas to provide switching diversity. One example of retransmission is hybrid automatic repeat request (HARQ) retransmission. However, this disclosure is not limited to HARQ retransmission, and other suitable retransmission schemes may be used. For the first SPS flow 502, the device may transmit a packet 508 (1^{st} Tx) using a first antenna (Ant 0), and retransmit the packet 510 (2^{nd} Tx) of the same flow using a second antenna (Ant 1). In one example, the first antenna (Ant 0) and second antenna (Ant 1) may be the antennas 404 and 406 illustrated in FIG. 4. For the second SPS flow 504, the device may transmit a packet 512 (1^{st} Tx) using Ant 0, and retransmit the packet 514 (2^{nd} Tx) using Ant 1. In this example, the device transmits the packets of both SPS flows using the first antenna first, and retransmits the packets using the second antenna. In other examples, the two SPS flows may use different patterns for alternating the antennas. For the event-driven flow 506, the device may transmit a packet 516 (1^{st} Tx) using Ant 0, and retransmit the packet 518 (2^{nd} Tx) using Ant 0. For each flow, the device alternates the transmit antennas for each transmission. Using switching diversity, two consecutive packets of the same flow are transmitted using different antennas.

When HARQ retransmission is used, the device may transmit a packet and retransmit the packet using chase-combining HARQ (HARQ-CC) or incremental redundancy HARQ (HARQ-IR). In HARQ-CC, a retransmission is identical to the original transmission. The information may then ideally be obtained error-free by virtue of a process called soft combining, where the redundant bits from the retransmission and the original transmission may be combined before decoding to increase the probability of correct reception of each bit. On the other hand, in HARQ-IR, the retransmitted code block may be different from the originally transmitted code block, and further, if multiple retransmissions are made, each retransmission may differ from one another. Here, retransmissions may include different sets of bits: for example, corresponding to different code rates or algorithms; corresponding to different portions of the original information block, some of which may not have been transmitted in the original transmission; corresponding to forward error correction (FEC) bits that were not transmitted in the original transmission; or other suitable schemes. As with HARQ-CC, here, the information may be obtained error-free by utilizing soft combining to combine the retransmitted bits with the original transmitted bits.

Each HARQ-IR transmission is typically referred to as a redundancy version, with the initial transmission of a packet (code block) being denoted RV0 (e.g., the initial redundancy version). The first IR retransmission of the packet may be referred to as RV1, the second IR retransmission of the packet may be referred to as RV2, and so on, up to RVN, corresponding to the maximum number of retransmissions allowed before the packet is considered lost. For most coding schemes, with HARQ-IR, the initial redundancy version of a packet (RV0) is self-decodable, meaning that no other transmissions are necessary for the receiver to be able to decode the packet. This is due to the fact that the initial redundancy version (RV0) typically includes substantially all of the systematic bits of the packet. However, subsequent redundancy versions (RV1 . . . RVN) typically include fewer systematic bits, and therefore, may be considered non-self-decodable. Thus, subsequent redundancy version transmissions require the initial redundancy version transmission to be able to decode the packet.

In one example, the device may transmit a packet using initial redundancy version (RV0) in a first transmission, and a different redundancy version (e.g., RV2) in the retransmission. In another example, the device may use a self-decodable modulation and coding scheme (MCS) for each the 1^{st} Tx and 2^{nd} Tx (retransmission) of a packet. Self-decodable MCS enables the receiving device to decode the packet even if only one transmission is successfully received. Therefore, the receiving device does not need to use, for example, HARQ recombining to decode the packet.

In one aspect of the disclosure, the device (e.g., vehicle 402) may select an antenna randomly or based on a predetermined method or rule, instead of simply alternating the antennas. In one example, the device may use a rule that selects an antenna with a predetermined probability. The probability of selecting different antennas may be unequal. For example, a certain antenna may be preferred because it is located at a better position, thus providing better coverage or less null. In another example, a preferred antenna may have a higher antenna gain. For example, if a first antenna (Ant 0) has a probability p of being selected, the probability of a second antenna (Ant 1) being selected is 1−p. The value of p may be configurable, and may have a default value (e.g., 0.5). In one example, if the device detects there is a significant antenna imbalance (e.g., difference in antenna gain) or performance difference between two antennas, the device may put more selection bias to the preferable antenna, e.g., p=0.6 or greater. This concept may be extended to three or more antennas with respective probabilities.

In some aspects of the disclosure, the device may use various alternating patterns for switching the Tx antennas to transmit V2X packets. In one example, the device may always select Ant 0 for the first transmission (1^{st} Tx) of a packet and Ant 1 for the retransmission (2^{nd} Tx). In another example, the device may select either Ant 0 or Ant 1 for the 1^{st} Tx, and select either Ant 0 or Ant for the 2^{nd} Tx. In another example, the device may randomly select Ant 0 or Ant 1 for the 1^{st} Tx, and then select the other antenna for the 2^{nd} Tx. In other examples, the device may use any predetermined patterns for selecting the Tx antennas. For example, the device may consider antenna gain, inter-packet gap, randomized or mixed patterns, or other metrics for selecting the Tx antennas. For example, the device may select the antenna with higher gain for the first transmission to maximize the probability of successful packet decoding after the first transmission. For another example, to reduce the variation of inter-packet gap, the device may select a fixed alternating pattern of Ant0, Ant1, Ant0, Ant1, Ant0, etc. Otherwise, the UE may select the pattern based on probabilistic methods or mixed patterns such as Ant 0, Ant 1, Ant 1, Ant 0, etc. In cases where HARQ retransmission is disabled, a randomized or mixed pattern may prevent pathological cases where for example one of two SPS flows is rarely decoded successfully because it always maps to an antenna with coverage nulls at the receiver.

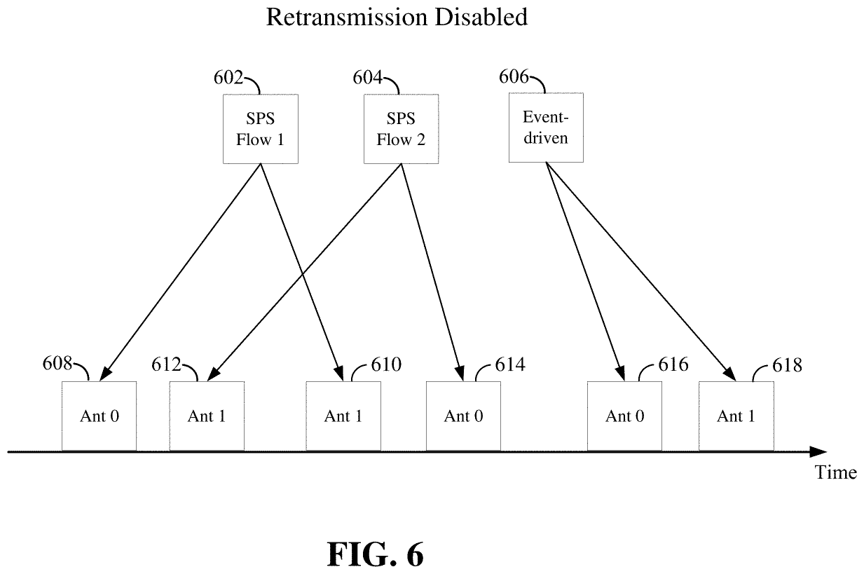

FIG. 6 is a diagram illustrating an exemplary communication process for transmitting V2X packets with retransmission disabled using switching diversity according to some aspects of the disclosure. This communication process may be performed by any device (e.g., UE or vehicle) illustrated in FIGS. 1, 2, 3, and/or 4 or any suitable apparatus. In one example, a device (e.g., UE or vehicle 402) may transmit two semi-persistent scheduled (SPS) flows (e.g., SPS flows 602 and 604) and an event-driven flow (e.g., event-driven flow 606). The SPS flows may be scheduled by a scheduling entity 108 via radio resource control (RRC) signaling or other semi-persistent scheduling methods. With retransmission disabled, the device transmits the data packets of the SPS flows and event-driven flow on alternating Tx antennas without retransmitting packets.

In one example, for the first SPS flow 602, the device may transmit a first packet 608 using a first antenna (Ant 0) and a second packet 610 using a second antenna (Ant 1). In this case, the second packet 610 is not a retransmission of the first packet 608. The first packet and second packet may be consecutive packets of the same flow. However, for the second SPS flow 604, the device may transmit a first packet 612 using Ant 1 and a second packet 614 using Ant 0. That is, the device uses different Tx antenna alternating (switching) patterns for transmitting the two different SPS flows. In some examples, the device may use the same antenna alternating pattern to transmit the packets of the different SPS flows. For the event-driven flow 606, the device may transmit a first packet 616 using Ant 0 and a second packet 618 using Ant 1. In this case, the device uses the same Tx antenna alternating pattern for transmitting the packets of the first SPS flow 602 and event-driven flow 606. In other examples, the device may use the same or different antenna alternating patterns for transmitting the packets of the SPS flows and event-driven flow.

The processes for using alternating antennas described above are not limited to two Tx antennas and/or V2X communications. In other aspects of the disclosure, these switching diversity processes may be extended to applications using two or more Tx antennas for various wireless communication methods.

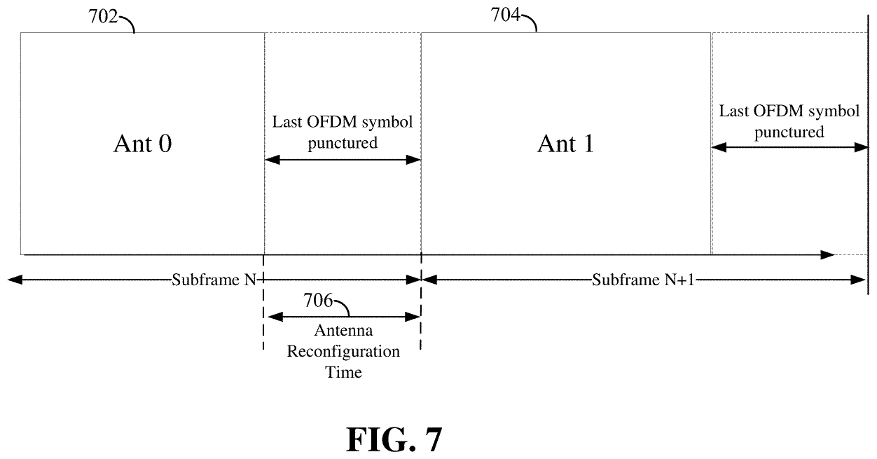

In some aspects of the disclosure, the device may use the same power amplifier (PA) of a radio frequency (RF) circuit to alternately drive different antennas (e.g., first antenna Ant 0 or second antenna Ant 1) for transmitting V2X packets using switching diversity. FIG. 7 is a drawing illustrating an antenna switching timeline when using switching diversity according to an aspect of the disclosure. In this example, a device (e.g., UE or vehicle 402) transmits a first packet 702 in a subframe N using a first Tx antenna (e.g., Ant 0). The device may puncture the last one or more OFDM symbols of subframe N so that the power amplifier is not driving the antenna (e.g., Ant 0) with any significant power during the punctured symbol(s). In some examples, the power amplifier may not output any power to the antenna during the last OFDM symbol or punctured symbol(s). Before the end of subframe N, the device reconfigures its RF chain circuit to use a different Tx antenna (e.g., Ant 1) to transmit the next packet 704. For example, the device may control RF switches to disconnect the power amplifier from the first antenna and connect the power amplifier to the second antenna. Because the power amplifier does not output any significant power during the reconfiguration time 706, potential damage to the power amplifier may be avoided due to the disconnection and reconnection between the power amplifier and the antennas. Furthermore, because the device reconfigures the antennas during the last OFDM symbol, no additional Tx blanking or time gap is needed between the Tx packets. Therefore, no additional overhead is added to switch the transmit antennas when switching diversity is used.

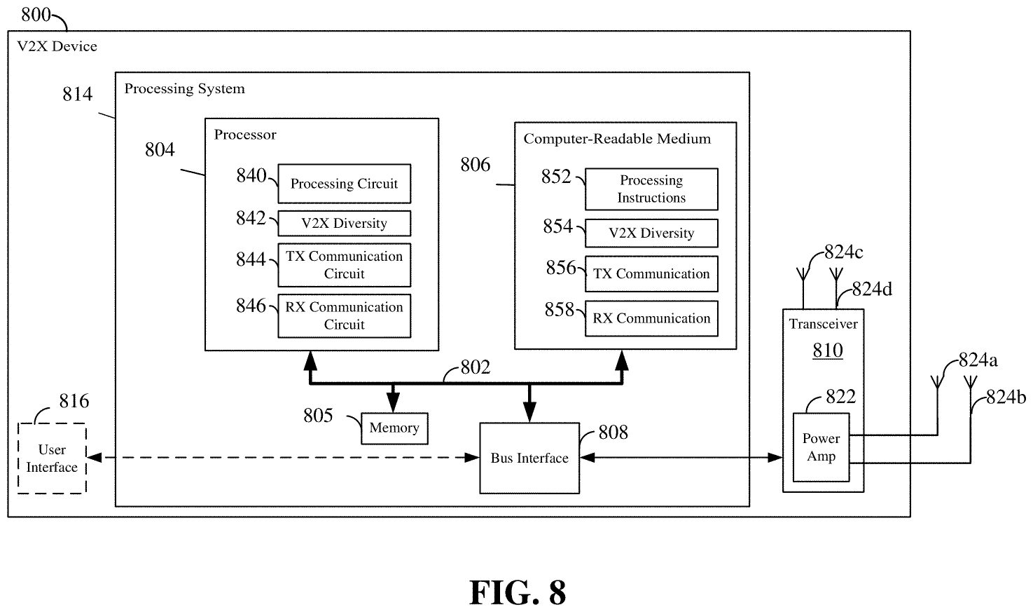

FIG. 8 is a block diagram illustrating an example of a hardware implementation for a V2X device 800 employing a processing system 814. For example, the V2X device 800 may be a user equipment (UE) or vehicle as illustrated in any one or more of FIGS. 1, 2, 3, and/or 4.

The V2X device 800 may be implemented with a processing system 814 that includes one or more processors 804. Examples of processors 804 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the V2X device 800 may be configured to perform any one or more of the functions and processes described herein. That is, the processor 804, as utilized in a V2X device 800, may be used to implement any one or more of the processes and procedures described below and illustrated in FIGS. 4-7, and 9-12.

In this example, the processing system 814 may be implemented with a bus architecture, represented generally by the bus 802. The bus 802 may include any number of interconnecting buses and bridges depending on the specific application of the processing system 814 and the overall design constraints. The bus 802 communicatively couples together various circuits including one or more processors (represented generally by the processor 804), a memory 805, and computer-readable media (represented generally by the computer-readable medium 806). The bus 802 may also link various other circuits such as timing sources, peripherals, voltage regulators, and power management circuits, which are well known in the art, and therefore, will not be described any further. A bus interface 808 provides an interface between the bus 802 and a transceiver 810. The transceiver 810 provides a communication interface or means for communicating with various other apparatus over a transmission medium. In some examples, the transceiver 810 may include an RF chain circuit coupled to two or more antennas 824 (illustrated as antennas 824a, 824b, 824c, 824d) for wireless communication. The antennas may include internal and/or external antennas. In one example, the V2X device may be a UE with one or more internal antennas (e.g., antennas 824c, 824d) and one or more external antennas (e.g., antennas 824a, 824b) for V2X communication. The external antennas may be antennas of a vehicle operatively and removably coupled to the UE. In some examples, the RF chain circuit may include a power amplifier 822 that may be configured to drive the antennas alternatively or one at a time when switching diversity is used. The RF chain circuit may include RF switches that can selectively connect or disconnect the power amplifier 822 to one or more antennas 824. Depending upon the nature of the apparatus, a user interface 816 (e.g., keypad, display, speaker, microphone, joystick) may also be provided. Of course, such a user interface 816 is optional, and may be omitted in some examples, such as a base station.

In some aspects of the disclosure, the processor 804 may include circuitry configured for various functions, including, for example, V2X communication functions described in relation to FIGS. 4-7, and 9-12. For example, the circuitry may include a processing circuit 840, a V2X diversity control block 842, a TX communication circuit 844, and an RX communication circuit 846. The processing circuit 840 may be configured to perform various data and signal processing functions and control processes during wireless communication as described in this disclosure. The V2X diversity control block 842 may be configured to perform various V2X communication functions using switching diversity as described in this disclosure. For example, the V2X diversity control block 842 may alternate TX antennas used for V2X communication using various procedures described in this disclosure. The TX communication circuit 844 may be configured to perform various wireless communication functions for transmitting signals using one or more of the antennas 824. The RX communication circuit 846 may be configured to perform various wireless communication functions for receiving signals using one or more of the antennas 824.

The processor 804 is responsible for managing the bus 802 and general processing, including the execution of software stored on the computer-readable medium 806. The software, when executed by the processor 804, causes the processing system 814 to perform the various functions described below for any particular apparatus. The computer-readable medium 806 and the memory 805 may also be used for storing data that is manipulated by the processor 804 when executing software.

One or more processors 804 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 806. The computer-readable medium 806 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 806 may reside in the processing system 814, external to the processing system 814, or distributed across multiple entities including the processing system 814. The computer-readable medium 806 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one or more examples, the computer-readable storage medium 806 may include software configured for various functions, including, for example, V2X communication. For example, the software may be configured to implement one or more of the functions and processes described in relation to FIGS. 4-7, 10, and 11. For example, the software may include processing instructions 852, V2X diversity control instructions 854, TX communication instructions 856, and RX communication instructions 858. The processing instructions 852 when executed may configure the processing system to perform various data and signal processing functions and control processes during wireless communication as described in this disclosure. The V2X diversity control instructions 854 when executed may configure the processing system to perform various V2X communication functions using switching diversity as described in this disclosure. The TX communication instructions 856 when executed may configure the processing system and transceiver to perform various wireless communication functions for transmitting signals using one or more of the antennas 824. The RX communication instructions 858 when executed may configure the processing system and transceiver to perform various wireless communication functions for receiving signals using one or more of the antennas 824.

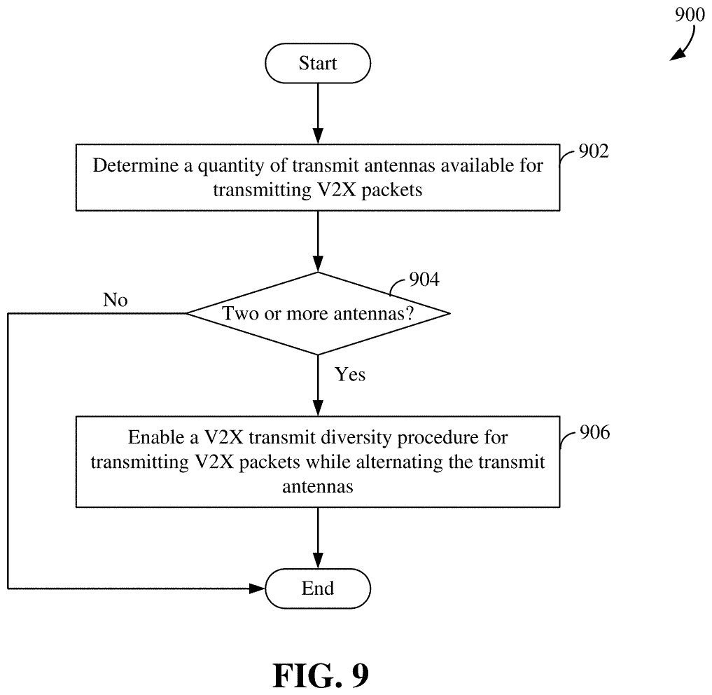

FIG. 9 is a flow chart illustrating a V2X communication process 900 using switching diversity according to some aspects of the disclosure. In some examples, the process 900 may be carried out by the vehicle 402 illustrated in FIG. 4, or any UE or vehicle capable of V2X communication using switching diversity. In some examples, the vehicle 402 may be the V2X device 800. In some examples, the process 900 may be carried out by any suitable apparatus or means for carrying out the functions or algorithm described below.

At block 902, a vehicle determines a quantity of transmit antennas available for transmitting data packets (e.g., V2X packets) using switching diversity. The vehicle may use a processing circuit (e.g., processing circuit 840) to determine the quantity of transmit (Tx) antennas available. For example, the vehicle may have a transceiver (e.g., transceiver 810) equipped with multiple antennas that can be used alternately to transmit packets. At decision block 904, if the vehicle determines that it has two or more Tx antennas available for transmitting V2X packets, the vehicle may enable a V2X transmit diversity (VTD) procedure for transmitting V2X packets using switching diversity (i.e., alternating the transmit antennas), at block 906. In one example, the vehicle may use a switching diversity control block (e.g., V2X diversity block 842) to determine how many Tx antennas are available for V2X communication. If the vehicle determines that it does not have two or more Tx antennas available for transmitting V2X packets using switching diversity, the vehicle may use a single antenna for transmitting the V2X packets.

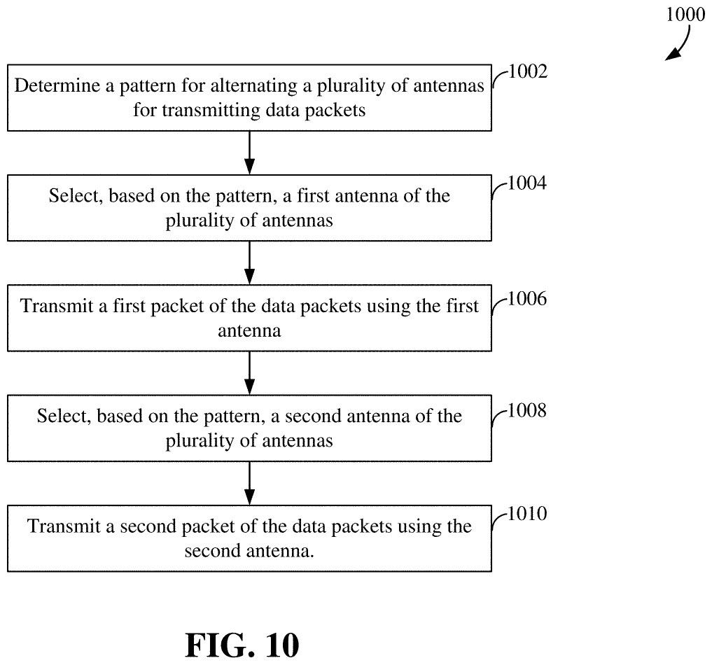

FIG. 10 is a flow chart illustrating a V2X transmit diversity (VTD) procedure 1000 according to some aspects of the disclosure. In some examples, the V2X VTD procedure 1000 may be carried out by the vehicle 402 in block 906 of FIG. 9 or any UE or vehicle to alternate the transmit antennas using switching diversity. In some examples, the procedure 1000 may be carried out by any suitable apparatus or means for carrying out the functions or algorithm described below.

At block 1002, the vehicle determines a pattern for alternating a plurality of antennas for transmitting data packets (e.g., V2X packets). For example, the vehicle may determine the pattern based on antenna imbalance, inter-packet gap, pathological patterns, and/or other metrics for selecting and alternating the Tx antennas to improve coverage or reduce any null in the coverage area. The vehicle may use a diversity control circuit (e.g., V2X diversity block 842) to determine the pattern. According to the pattern, the vehicle alternates or switches the Tx antennas when transmitting data packets. When the vehicle alternates the Tx antennas, the vehicle transmits the packets using only the selected antenna(s), and the unselected Tx antenna(s) may be electronically or physically disconnected from the power amplifier of the transceiver.

At block 1004, the vehicle selects a first antenna of the plurality of antennas, based on the pattern. In some examples, the vehicle may randomly select the first antenna. In some examples, the vehicle may select the first antenna based on a predetermined rule. In some examples, the vehicle may select the first antenna based on probabilities associated with the antennas. The vehicle may use the V2X diversity block 842 to select the first antenna. For example, the V2X diversity block may configure an RF chain circuit in the transceiver to enable the selected antenna and disable the unselected antennas. The disabled antenna may be physically or electronically disconnected from the power amplifier of the RF chain circuit. At block 1006, the vehicle transmits a first packet of the plurality of data packets using the first antenna. For example, the vehicle may use a processing circuit (e.g., processing circuit 840) to control a communication circuit (e.g., TX communication circuit 844) and a transceiver (e.g., transceiver 810) to transmit the first packet (e.g., V2X packet) using the first antenna (e.g., antenna 824a).

At block 1008, the vehicle selects a second antenna of the plurality of antennas, based on the pattern. In some examples, the vehicle may randomly select the second antenna. In some examples, the vehicle may select the second antenna based on a predetermined rule for switching the antennas. In some examples, the vehicle may select the second antenna based on probabilities associated with the antennas. The vehicle may use the V2X diversity block 842 to select the second antenna. In some examples, the second antenna may be different from the first antenna. At block 1010, the vehicle transmits a second packet of the plurality of data packets using the second antenna. For example, the vehicle may use the processing circuit (e.g., processing circuit 840) to control the a communication circuit (e.g., TX communication circuit 844) and a transceiver (e.g., transceiver 810) to transmit the second packet (e.g., V2X packet) using the second antenna (e.g., antenna 824b).

The above described switching diversity processes may be repeated for transmitting subsequent packets after the first and second packets.

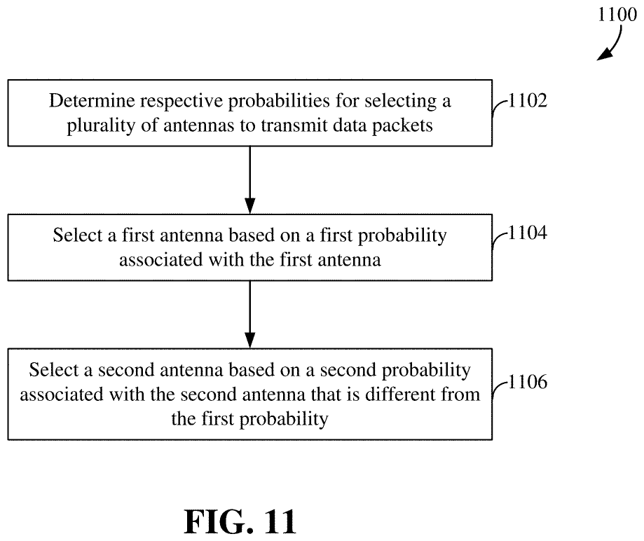

FIG. 11 is a flow chart illustrating a process 1100 for alternating antennas in V2X communication according to some aspects of the disclosure. In one example, a V2X device (e.g., UE or vehicle) may use this process to alternate the transmit antennas when performing the VTD procedure 1000 described above. At block 1102, a V2X device may determine respective probabilities for selecting a plurality of antennas to transmit data packets. An antenna with higher probability is more likely to be selected. The V2X device may determine the probabilities based on various factors, for example, antenna imbalance, performance difference between antennas. At block 1104, the V2X device may select a first antenna based on a first probability associated with the first antenna. At block 1104, the V2X device may select a second antenna based on a second probability associated with the second antenna that is different from the first probability.

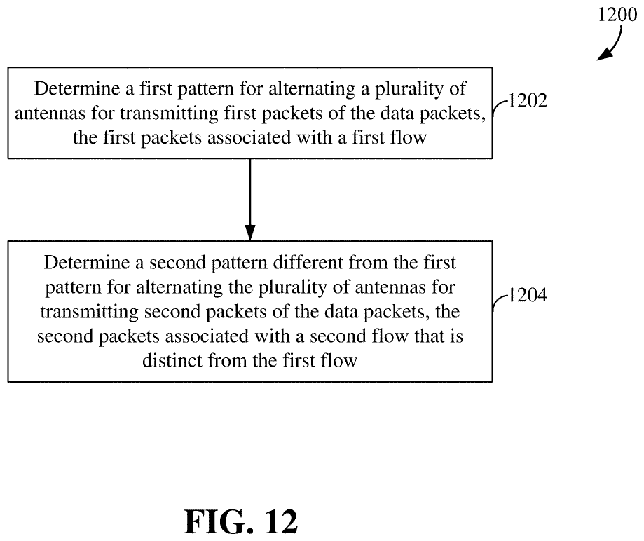

FIG. 12 is a flow chart illustrating a process 1200 for alternating antennas in V2X communication according to some aspects of the disclosure. In one example, a V2X device (e.g., UE or vehicle) may use this process to alternate the transmit antennas when performing the VTD procedure 1000 described above. At block 1202, a V2X device determines a first pattern for alternating a plurality of antennas for transmitting first packets of data packets. The first packets are associated with a first flow (e.g., SPS flow or event-driven flow). At block 1204, the V2X device determines a second pattern different from the first pattern for alternating the plurality of antennas for transmitting second packets of the data packets. The second packets are associated with a second flow (e.g., SPS flow or even driven flow) that is distinct from the first flow.

In one configuration, the apparatus 800 for wireless communication includes means for determining a pattern for alternating a plurality of antennas for transmitting data packets using switching diversity; means for selecting, based on the pattern, a first antenna of the plurality of antennas; means for transmitting a first packet of the data packets using the first antenna; means for selecting, based on the pattern, a second antenna of the plurality of antennas; and means for transmitting a second packet of the data packets using the second antenna.

In one aspect of the disclosure, the aforementioned means may be the processor 804, computer-readable medium 806, and transceiver 810 shown in FIG. 8 configured to perform the functions recited by the aforementioned means. In another aspect, the aforementioned means may be a circuit or any apparatus configured to perform the functions recited by the aforementioned means.

Of course, in the above examples, the circuitry included in the processor 804 is merely provided as an example, and other means for carrying out the described functions may be included within various aspects of the present disclosure, including but not limited to the instructions stored in the computer-readable storage medium 806, or any other suitable apparatus or means described in any one of the FIGS. 1, 2, 3, and/or 4, and utilizing, for example, the processes and/or algorithms described herein in relation to FIGS. 10 and/or 11.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as New Radio (NR), Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-12 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-4 and 8 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A method of vehicle-to-everything (V2X) wireless communication operable at a user equipment (UE), comprising:
determining a pattern for alternating a plurality of antennas operatively coupled to the UE for transmitting data packets;
selecting, based on the pattern, a first antenna of the plurality of antennas;
transmitting a first packet of the data packets using the first antenna;
selecting, based on the pattern, a second antenna of the plurality of antennas; and
transmitting a second packet of the data packets using the second antenna.

2. The method of claim 1, wherein the determining the pattern comprises:
determining respective probabilities for selecting the plurality of antennas.

3. The method of claim 2, wherein the selecting the first antenna comprises selecting the first antenna based on a first probability associated with the first antenna, and the selecting the second antenna comprises selecting the second antenna based on a second probability associated with the second antenna, the second probability is different from the first probability.

4. The method of claim 2, wherein the selecting the first antenna comprises selecting the first antenna based on a first probability associated with the first antenna, and the selecting the second antenna comprises selecting the second antenna based on a second probability associated with the second antenna, the second probability is equal to the first probability.

5. The method of claim 1, wherein the determining the pattern comprises:
determining a first pattern for alternating the plurality of antennas for transmitting first packets of the data packets, and a second pattern for alternating the plurality of antennas for transmitting second packets of the data packets, wherein first packets are associated with a first flow and the second packets are associated with a second flow that is distinct from the first flow.

6. The method of claim 5, wherein the first pattern is different from the second pattern.

7. The method of claim 5, wherein the first flow comprises a semi-persistent scheduled data flow, and the second flow comprises an event-driven data flow.

8. The method of claim 1, further comprising:
randomly selecting a third antenna of the plurality of antennas; and
transmitting a third packet of the data packets using the third antenna.

9. The method of claim 1, wherein the determining the pattern comprises:
determining the pattern for alternating the plurality of antennas based on at least one of an antenna imbalance of the plurality of antennas or a time gap between the data packets.

10. The method of claim 1,
wherein the transmitting the first packet comprises transmitting the first packet using a first redundancy version; and
wherein the transmitting the second packet comprises retransmitting the first packet as the second packet using a second redundancy version that is different from the first redundancy version.

11. The method of claim 1, further comprising:
transmitting the first packet and the second packet using a self-decodable modulation and coding scheme.

12. The method of claim 1, wherein the transmitting the first packet using the first antenna comprises disabling other antennas of the plurality of antennas while transmitting the first packet using the first antenna.

13. The method of claim 1, wherein the transmitting the first packet comprises:
puncturing a last symbol of the first packet; and
reconfiguring, during the last symbol of the first packet, the plurality of antennas for transmitting the second packet using the second antenna.

14. The method of claim 1,
wherein the selecting the first antenna comprises selecting an antenna internal to the UE; and
wherein the selecting the second antenna comprises selecting an antenna external to the UE.

15. A user equipment (UE) for use in vehicle-to-everything (V2X) wireless communication, the UE comprising:
a communication interface configured for wireless communication using a plurality of antennas;
a memory; and
a processor operatively coupled with the communication interface and the memory,
wherein the processor and the memory are configured to:
determine a pattern for alternating the plurality of antennas for transmitting data packets;
select, based on the pattern, a first antenna of the plurality of antennas;
transmit a first packet of the data packets using the first antenna;
select, based on the pattern, a second antenna of the plurality of antennas; and
transmit a second packet of the data packets using the second antenna.

16. The UE of claim 15, wherein the processor and the memory are further configured to:
determine respective probabilities for selecting the plurality of antennas.

17. The UE of claim 16, wherein the processor and the memory are further configured to:
select the first antenna based on a first probability associated with the first antenna; and
select the second antenna based on a second probability associated with the second antenna, the second probability is different from the first probability.

18. The UE of claim 16, wherein the processor and the memory are further configured to:
select the first antenna based on a first probability associated with the first antenna; and
select the second antenna based on a second probability associated with the second antenna, the second probability is equal to the first probability.

19. The UE of claim 15, wherein the processor and the memory are further configured to determine a first pattern for alternating the plurality of antennas for transmitting first packets of the data packets, and a second pattern for alternating the plurality of antennas for transmitting second packets of the data packets, wherein first packets are associated with a first flow and the second packets are associated with a second flow that is distinct from the first flow.

20. The UE of claim 19, wherein the first pattern is different from the second pattern.

21. The UE of claim 19, wherein the first flow comprises a semi-persistent scheduled data flow, and the second flow comprises an event-driven data flow.

22. The UE of claim 15, wherein the processor and the memory are further configured to:
randomly select a third antenna of the plurality of antennas; and
transmitting a third packet of the data packets using the third antenna.

23. The UE of claim 15, wherein the processor and the memory are further configured to:
determine the pattern for alternating the plurality of antennas based on at least one of an antenna imbalance of the plurality of antennas or a time gap between the data packets.

24. The UE of claim 15, wherein the processor and the memory are further configured to:
transmit the first packet using a first redundancy version; and
retransmit the first packet as the second packet using a second redundancy version that is different from the first redundancy version.

25. The UE of claim 15, wherein the processor and the memory are further configured to:
transmit the first packet and the second packet using a self-decodable modulation and coding scheme.

26. The UE of claim 15, wherein the processor and the memory are further configured to:
disable other antennas of the plurality of antennas while transmitting the first packet using the first antenna.

27. The UE of claim 15, wherein the processor and the memory are further configured to:
puncture a last symbol of the first packet; and
reconfigure, during the last symbol of the first packet, the plurality of antennas for transmitting the second packet using the second antenna.

28. The UE of claim 15, further comprising the plurality of antennas that are coupled to the communication interface.

29. The UE of claim 15, wherein the processor and the memory are further configured to:
select an antenna internal to the UE as the first antenna; and
select an antenna external to the UE as the second antenna.

30. A user equipment (UE) configured for vehicle-to-everything (V2X) wireless communication, the UE comprising:
means for determining a pattern for alternating a plurality of antennas for transmitting data packets;
means for selecting, based on the pattern, a first antenna of the plurality of antennas;
means for transmitting a first packet of the data packets using the first antenna;
means for selecting, based on the pattern, a second antenna of the plurality of antennas; and
means for transmitting a second packet of the data packets using the second antenna.

31. The UE of claim 30, wherein the means for determining the pattern is configured to:
determine respective probabilities for selecting the plurality of antennas.

32. The UE of claim 31, wherein the means for selecting the first antenna is configured to select the first antenna based on a first probability associated with the first antenna, and the means for selecting the second antenna is configured to select the second antenna based on a second probability associated with the second antenna, the second probability is different from the first probability.

33. The UE of claim 31, wherein the means for selecting the first antenna is configured to select the first antenna based on a first probability associated with the first antenna, and the means for selecting the second antenna is configured to select the second antenna based on a second probability associated with the second antenna, the second probability is equal to the first probability.

34. The UE of claim 30, wherein the means for determining the pattern is configured to determine a first pattern for alternating the plurality of antennas for transmitting first packets of the data packets, and a second pattern for alternating the plurality of antennas for transmitting second packets of the data packets, wherein first packets are associated with a first flow and the second packets are associated with a second flow that is distinct from the first flow.

35. The UE of claim 34, wherein the first pattern is different from the second pattern.

36. The UE of claim 34, wherein the first flow comprises a semi-persistent scheduled data flow, and the second flow comprises an event-driven data flow.

37. The UE of claim 30, further comprising:
means for randomly selecting a third antenna of the plurality of antennas, and
means for transmitting a third packet of the data packets using the third antenna.

38. The UE of claim 30, wherein the means for determining the pattern is configured to:
determine the pattern for alternating the plurality of antennas based on at least one of an antenna imbalance of the plurality of antennas or a time gap between the data packets.

39. The UE of claim 30,
wherein the means for transmitting the first packet is configured to transmit the first packet using a first redundancy version, and
wherein the means for transmitting the second packet is configured to retransmit the first packet as the second packet using a second redundancy version that is different from the first redundancy version.

40. The UE of claim 30,
wherein the means for transmitting the first packet is configured to transmit the first packet using a self-decodable modulation and coding scheme (MCS), and
wherein the means for transmitting the second packet is configured to transmit the second packet using the self-decodable MCS.

41. The UE of claim 30, wherein the means for transmitting the first packet is configured to disable other antennas of the plurality of antennas while transmitting the first packet using the first antenna.

42. The UE of claim 30, wherein the means for transmitting the first packet is configured to:
puncture a last symbol of the first packet; and
reconfigure, during the last symbol of the first packet, the plurality of antennas for transmitting the second packet using the second antenna.

43. An article of manufacture for use by a user equipment (UE) for vehicle-to-everything (V2X) wireless communication, the article comprising:
a non-transitory computer-readable storage medium having stored therein instructions executable by one or more processors of the UE to:
determine a pattern for alternating a plurality of antennas for transmitting data packets;
select, based on the pattern, a first antenna of the plurality of antennas;
initiate transmission of a first packet of the data packets using the first antenna;
select, based on the pattern, a second antenna of the plurality of antennas; and
initiate transmission of a second packet of the data packets using the second antenna.

44. The article of manufacture of claim 43, further comprising instructions executable by the one or more processors to:
determine respective probabilities for selecting the plurality of antennas.

45. The article of manufacture of claim 44, further comprising instructions executable by the one or more processors to:
select the first antenna based on a first probability associated with the first antenna; and
select the second antenna based on a second probability associated with the second antenna, the second probability is different from the first probability.

46. The article of manufacture of claim 44, further comprising instructions executable by the one or more processors to:
select the first antenna based on a first probability associated with the first antenna; and
select the second antenna based on a second probability associated with the second antenna, the second probability is equal to the first probability.

47. The article of manufacture of claim 43, further comprising instructions executable by the one or more processors to:
determine a first pattern for alternating the plurality of antennas for transmitting first packets of the data packets, and a second pattern for alternating the plurality of antennas for transmitting second packets of the data packets,
wherein first packets are associated with a first flow and the second packets are associated with a second flow that is distinct from the first flow.

48. The article of manufacture of claim 47, wherein the first pattern is different from the second pattern.

49. The article of manufacture of claim 47, wherein the first flow comprises a semi-persistent scheduled data flow, and the second flow comprises an event-driven data flow.

50. The article of manufacture of claim 43, further comprising instructions executable by the one or more processors to:
randomly select a third antenna of the plurality of antennas; and
initiate transmission of a third packet of the data packets using the third antenna.

51. The article of manufacture of claim 43, further comprising instructions executable by the one or more processors to:
determine the pattern for alternating the plurality of antennas based on at least one of an antenna imbalance of the plurality of antennas or a time gap between the data packets.

52. The article of manufacture of claim 43, further comprising instructions executable by the one or more processors to:
initiate transmission of the first packet using a first redundancy version; and
initiate retransmission of the first packet as the second packet using a second redundancy version that is different from the first redundancy version.

53. The article of manufacture of claim 43, further comprising instructions executable by the one or more processors to:
initiate transmission of the first packet and the second packet using a self-decodable modulation and coding scheme.

54. The article of manufacture of claim 43, further comprising instructions executable by the one or more processors to:
disable other antennas of the plurality of antennas while transmitting the first packet using the first antenna.

55. The article of manufacture of claim 43, further comprising instructions executable by the one or more processors to:
puncture a last symbol of the first packet; and
reconfigure, during the last symbol of the first packet, the plurality of antennas for transmitting the second packet using the second antenna.

56. The article of manufacture of claim 43, further comprising instructions executable by the one or more processors to:
select an antenna internal to the UE as the first antenna; and
select an antenna external to the UE as the second antenna.
